(19) United States
(12) Patent Application Publication
(10) Pub. No.: US 2006/0282818 A1
(43) Pub. Date: Dec. 14, 2006

(54) Interactive formula builder

(75) Inventor: Stuart N. DeSpain, Seattle, WA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/152,498

(22) Filed: Jun. 14, 2005

(51) Int. Cl. G06F 9/44

(52) U.S. Cl. 717/109

(57) ABSTRACT

The present invention provides a method for building idiosyncratic mathematical formulas in a software application program such as a computerized spreadsheet. The method allow users to access desired functions and formulas, enter arguments used by the functions and formulas, and illustrate how the functions operate, all in a straight forward and easy to understand methodology.

### BACKGROUND OF THE INVENTION

1. Field of the Invention

The present invention is directed to methods for building mathematical formulas in a software application program.

2. Description of the Related Art

Computerized spreadsheets have become widely used for organizing numerical and textual data. These software application programs, such as for example Microsoft® Office Excel, are executed by a processor to provide the user with a graphical presentation of a spreadsheet, and tools for entering information on the spreadsheet. The spreadsheets may consist of rows and columns of individual cells. The columns may be organized by letter—Columns A, B, C, etc.—and the rows are organized by number—Rows 1, 2, 3, etc. Each cell is identified by a combination of column letter and row number. Cell “B3,” for instance, is in column B and row 3. The user can organize numerical and/or textual data in the cells of the spreadsheet as desired using the computer's graphical user interface, and can format the numerical and/or textual data so as to be recognized as one of a variety of data classes, including text, dates, currency, integers and/or floating point numbers.

Current spreadsheet programs also use formulas to allow users to specify mathematical functions to be taken on a series of numbers. In order to perform calculations on the data entered into the spreadsheet, the author generally has to explicitly define the function and enter it in one of the cells. (Some functions, such as summation, have auto-calculation shortcuts allowing the function to be performed without defining and entering the function in a cell. Such auto-calculation shortcuts are described in U.S. Pat. No. 6,055,548 entitled, “Computerized Spreadsheet with Auto-Calculator.”)

The formulas are set apart from normal data by use of a leading descriptor entry, such as an “=” sign. It is common for the mathematical formulas entered in one cell to use data contained in other cells. The formula itself is not displayed in the cell; rather, the cell displays the results of the formula.

One typical spreadsheet example is to multiply two or more numbers together from a row. The author selects a cell in the spreadsheet which will be used to show the product, and in that cell, defines a product function which multiplies the values of the selected cells in the row (by themselves and/or by a defined constant). For example, to compute 50% of the product of numbers residing in cells B2, C2, D2 and E2 and show that sum in cell F2, the user enters in cell F2 one of the following equations:

$$\begin{matrix}= PRODUCT ( 0.5 , B 2 , C 2 , D 2 , E 2 ) \\ = PRODUCT ( 0.5 , ( B 2 \text{:} E 2 ) ) \\ = 0.5 * B 2 * C 2 * D 2 * E 2\end{matrix}$$

The formula begins with the “=” descriptor to identify that the cell contains a formula, and not text or numerical data.

For commonly used equations, spreadsheet applications typically have a predefined list of functions from which the author may choose. The list can be presented in a pop-up menu, pull-down menu, or the like. The author simply chooses a particular cell and selects a function from the predefined list. The spreadsheet enters the selected function into the chosen cell, so that the author does not have to type in the function. In addition to predefined lists, Microsoft® Office Excel offers a “function wizard” which guides the author step-by-step through the parts of a function to ensure entry of the appropriate cell information and parameters.

### SUMMARY OF THE INVENTION

The present invention relates to methods for building mathematical formulas in a software application program such as a computerized spreadsheet. In particular, conventional spreadsheet application programs typically include a large number of prewritten functions allowing users to perform a variety of operations on and with numbers, dates, times, text, and more. Embodiments of the present invention allow users to access desired functions and formulas, enter arguments used by the functions and formulas, and, in embodiments, illustrate how the functions and formulas operate, all in a straight forward and easy to understand methodology.

In accordance with embodiments of the present invention, a spreadsheet application program includes a formula builder tool for simplifying the creation of functions. Upon selection of the formula builder tool, the spreadsheet application program generates a formula builder window on the computer display. The formula builder window is populated with various fields, including a search field, a library field, a description field and an arguments field.

A user may enter a search in the search field relating to a function the user desires to perform. In embodiments of the invention, the search field may accept natural language search terms. The results of the search are returned in the library field. Upon selection of the appropriate function from the library, a description of the function may be provided in the description field, and the arguments field may be customized to accept information relating to the arguments required for the operation of the selected function. In embodiments, the arguments field may present one or more argument templates which facilitate the entry of cell ranges and other information required for the operation of the function. The argument templates allow arguments to be easily added to a function without the user having to know or necessarily understand the proper syntax required for the selected function.

Moreover, according to embodiments of the present invention, in order to allow a user to easily see which cells form a given argument to a function, both the argument template and the cells included in the argument template may be color coded with a background color. If more than one argument is included, the subsequent argument templates and cells included in each subsequent argument template may also be color coded with additional background colors. Thus, a user may easily see which cells are used in which arguments and how the overall results of the function are derived.

### BRIEF DESCRIPTION OF THE DRAWINGS

FIG. 1 is a block diagram of computer hardware suitable for implementing embodiments of the invention.

FIG. 2 is a spreadsheet window presented by the application program according to the present invention.

FIG. 3 is a flowchart of a process for performing the application program according to the present invention.

FIG. 3A is a continuation of the flowchart shown in FIG. 3.

FIG. 4 is a spreadsheet window including a formula builder window presented by the application program according to the present invention.

FIG. 4A is an enlarged view of a formula builder window including a drop down menu according to the present invention.

FIGS. 5-8 are spreadsheet windows including a formula builder window presented by the application program according to the present invention at different stages of use.

FIG. 8A is an enlarged view of a formula builder window including an argument field for entering information regarding the arguments used by a function according to embodiments of the present invention.

FIG. 9 is a spreadsheet window including a formula builder window presented by the application program according to the present invention receiving information about a first argument.

FIG. 9A is an enlarged view of a formula builder window including an argument field for entering information regarding the arguments used by a function according to embodiments of the present invention.

FIG. 10 is a spreadsheet window including a formula builder window presented by the application program according to the present invention receiving information about a second argument.

FIG. 11 is a spreadsheet window including a formula builder window according to the present invention showing the example of building an IF function.

### DETAILED DESCRIPTION

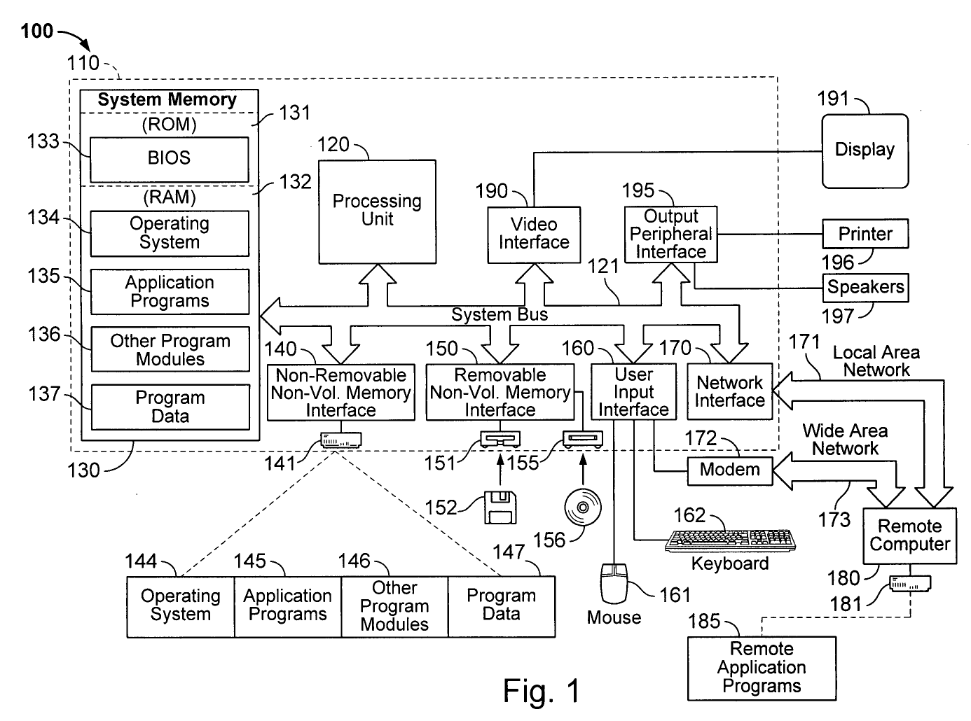

Embodiments of the invention will now be described with reference to FIGS. 1-11, which in general relate to methods for building mathematical formulas in a software application such as a computerized spreadsheet. In embodiments, the invention relates to a search/visual interface approach to formula building and execution designed to simplify the formula creation process. First, the various functions that are provided are made searchable. Search functions are indexed by letters, metadata, and/or classification. Inline results enable a user to quickly find a function. Thereafter, when the user selects data to which to apply the function, the data may be color coded on the main screen by its use in the function. This allows the users to understand visually the effect of the function on the data in the worksheet.

The methods described herein can be performed on a variety of processing systems. FIG. 1 illustrates an example of a suitable general computing system environment 100 on which the invention may be implemented. The computing system environment 100 is only one example of a suitable computing environment and is not intended to suggest any limitation as to the scope of use or functionality of the invention. Neither should the computing system environment 100 be interpreted as having any dependency or requirement relating to any one or combination of components illustrated in the exemplary computing system environment 100.

The invention is operational with numerous other general purpose or special purpose computing systems, environments or configurations. Examples of well known computing systems, environments and/or configurations that may be suitable for use with the invention include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. These components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The application programs 135 stored in system memory 130 may include a spreadsheet application program for performing the present invention as described hereinafter. The spreadsheet application program may additionally include all other functionality of conventional spreadsheet application programs such as for example Microsoft® Office Excel from Microsoft Corporation, Lotus® 1-2-3 from Lotus Software, and/or other spreadsheet application program. When the spreadsheet application program is launched, it runs on the operating system 134 while executing on the processing unit 120. An example of an operating system on which the spreadsheet application program may run is the Macintosh operating system by Apple Computer, Inc., but the spreadsheet application program may be operate on a variety of operating systems including also the Windows® operating system from Microsoft Corporation, or the Linux operating system from Sun Microsystems, Inc. The spreadsheet application program may be loaded into the memory 130 from the CD-ROM 155, or alternatively, downloaded from over network 171 or 173.

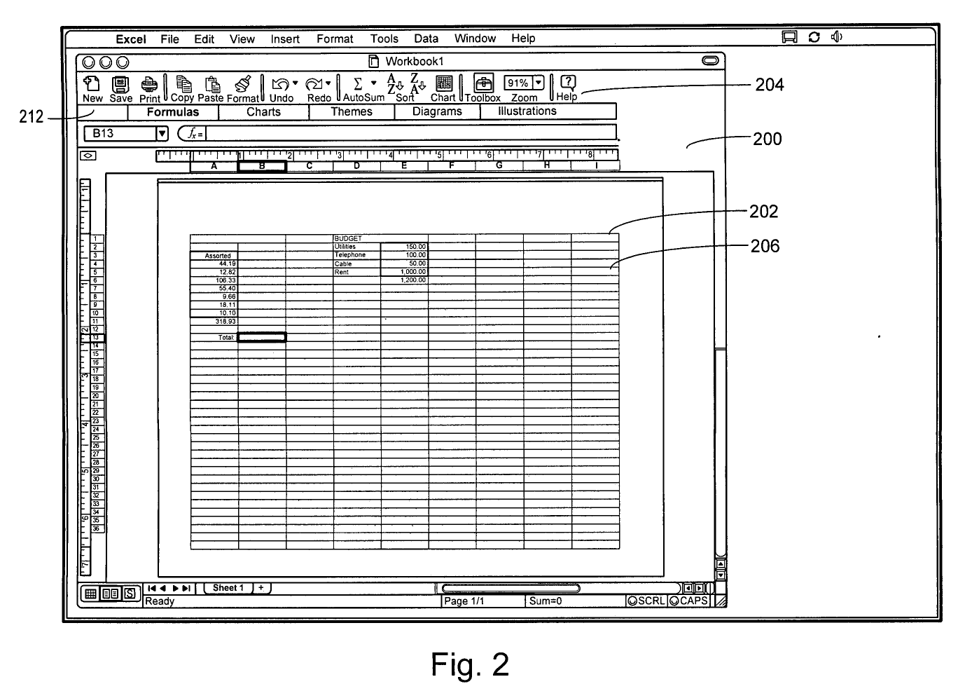

The spreadsheet application program may include some or all of the tools, functionality and features of Microsoft® Office Excel and/or other conventional spreadsheet application programs. Upon launching the spreadsheet application program, a graphical user interface is presented on monitor 191 as shown in FIG. 2, including spreadsheet window 200 having spreadsheet 202 and tools 204 for entering and managing information on spreadsheet 202. Spreadsheet 202 may consist of rows and columns of individual cells 206. The columns may be organized by letter—Columns A, B, C, etc.—and the rows may be organized by number—Rows 1, 2, 3, etc., although the column and row designations may be switched or represented otherwise in alternative embodiments. There may be more or less columns and rows than shown in FIG. 2. Each cell 205 may be identified by a combination of column letter and row number. Cell “B3,” for instance, may be in column B and row 3. In FIG. 2, columns of text and numbers are provided in columns A, D and E. The text and numbers are used to illustrate the operation of the present invention only, and the amount and position of text, numbers and other information on graphical spreadsheet 202 may vary.

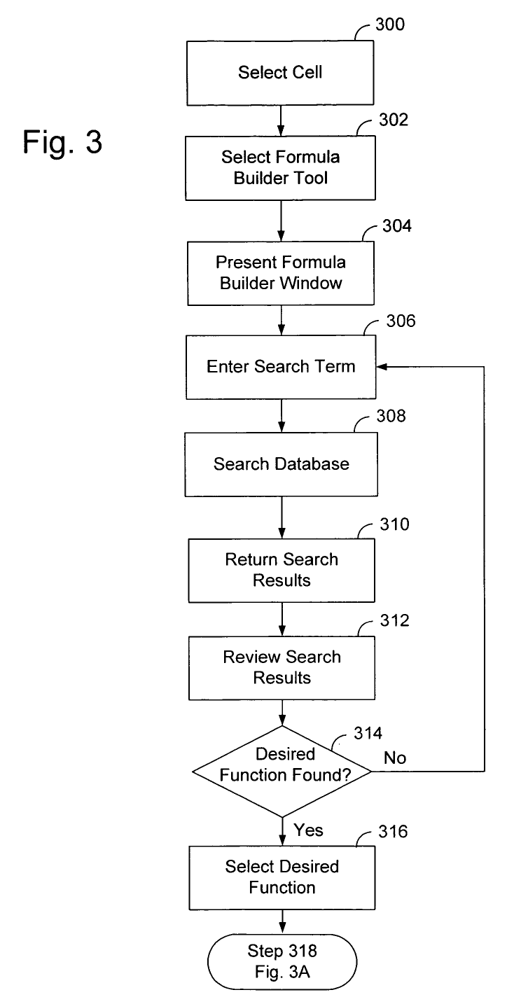

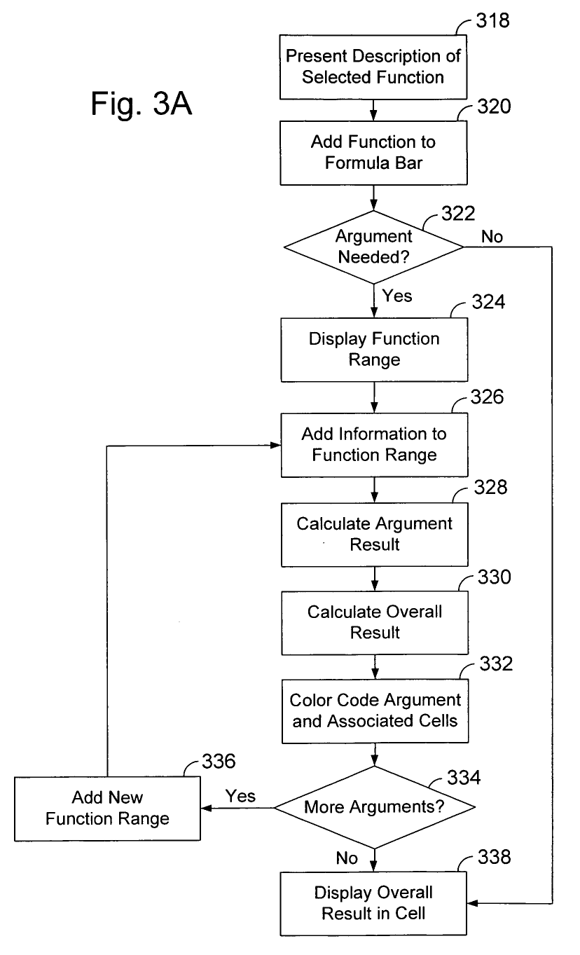

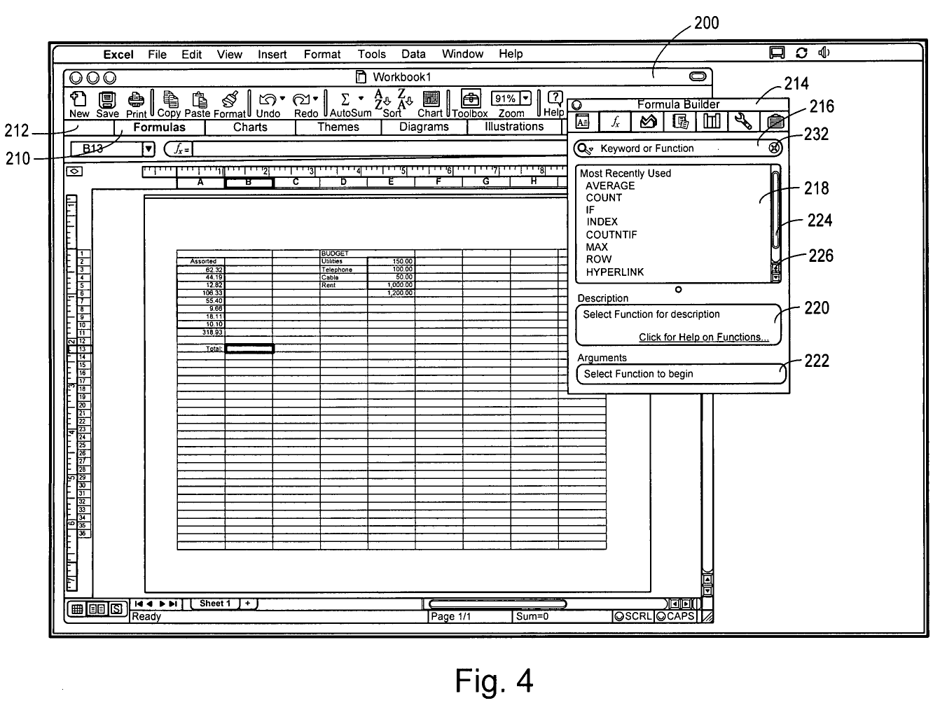

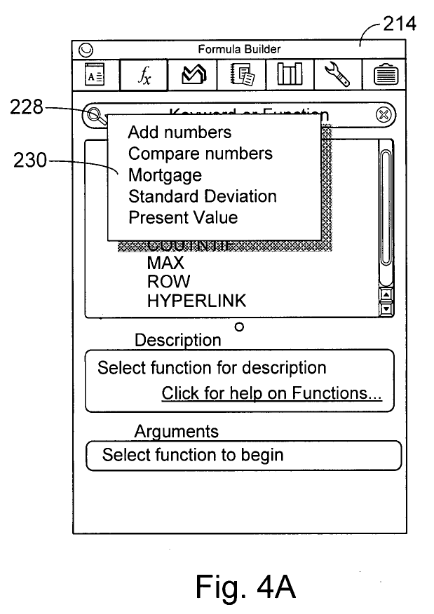

In accordance with the present invention, the spreadsheet application program includes a formula builder tool for simplifying the creation of functions. As used herein, a “function” is any function, formula or other operation that may be built using the formula builder tool as described hereinafter. The operation of the formula builder tool is explained with reference to the flowchart of FIG. 3 and the user interface set presented in FIGS. 4-11. When a user wants to perform a certain function and have the results of that function appear in a particular cell, the user first selects the desired cell in step 300, such as for example cell B13 as shown in FIG. 4. The formula builder tool may then be launched in step 302 by selecting the formula builder tab 210 with the pointing device 161 from a toolbar 212 on window 200. It would be appreciated that the formula builder tool may be selected, with the pointing device 161 and/or keyboard 162, a variety of other ways, including from one of the options under on the menu bar, such as “Insert>Function.”

Upon selection of the formula builder tool, the spreadsheet application program displays a formula builder window 214 on the display 191 in step 304. Window 214 may be resized and moved around the display as is known in the art. The formula builder window 214 is populated with various fields, including a search field 216, a library field 218, a description field 220 and an arguments field 222, each of which is described hereinafter.

Search field 216 includes a text box for accepting a search term relating to a function the user would like to perform. In step 306, the user enters a search term in search field 216 relating to the desired function, or more generally, what the user would like to do with the information in the spreadsheet 202. The search term may be a natural language query entered using keyboard 162.

In embodiments, the search term entered in search field 216 may comprise any characters, and may be 255 characters long, although the search term may be longer or shorter than that in alternative embodiments. If the user attempts to exceed the maximum allowed characters, the spreadsheet application program can ignore the additional input and issue an alert. Field 216 may or may not be wide enough to accept the maximum allowable number of characters in the search term. Where the length of text in a search term exceeds the available visible space in field 216, the text may run off to the right and/or left of the visible field 216. Users can use the arrow keys on keyboard 162 to move through the text of a search term.

Search terms entered in previous searches may be stored in memory such that, upon accessing a search menu button 228, a number of the previous search terms may be presented as shown in FIG. 4A. In one embodiment, upon accessing search menu button 228, as many as the previous ten search terms may be presented in a drop down menu 230. Greater or lesser than ten prior search terms may be shown in drop down menu 230 in alternative embodiments. Selecting one of the prior search terms with the pointing device 161 will cause the drop down menu 230 to be removed and the selected search term to be searched in search field 216. The drop down menu may alternatively be removed from the display screen by clicking with the pointing device 161 outside of the drop down menu 230 or hitting the escape button on keyboard 162. Search menu button 228 and drop down menu 230 may be omitted in alternative embodiments.

Referring again to FIG. 4, the search field 216 may be cleared of an existing search term by deleting the text using the backspace and delete keys of keyboard 162, or by using pointing device 161 on a clear button 232 within search field 216. Clear button 232 may be omitted in alternative embodiments.

Instead of typing in a search term, the search term may be chosen from a list of terms presented to the user in library field 218. Namely, when search field 216 is blank (for example displaying “Keyword or Function”), the library field 218 may present a list of possible functions to choose from as the search term. The library list of search terms may for example present those which have been most recently chosen (the search terms AVERAGE, COUNT, IF, etc. shown in FIG. 4 are by way of example and may be a variety of other known functions and/or formulas). The library list of search terms may be organized otherwise, such as for example displaying an alphabetical list of functions, or displaying functions grouped by category.

The library list of search terms may include more than those visible within the library field 218 at a given time, with additional search terms being accessed by scrolling up or down using the mouse pointing device 161 on scroll bar 224 or up and down arrow buttons 226. Additionally, alpha matching may be included as is known in the art, where the user types one or more characters on keyboard 162, and the operating system finds the first term in library field 218, if any, with the selected character(s) at the beginning of the term. The scroll bar 224, arrow buttons 226 and/or alpha matching may be omitted in alternative embodiments, and the library field 218 may only present a number of search terms that are visible within the library field in alternative embodiments.

Upon entry of a search term, either by keying in the search term or selecting a search term from library field 218, the user may hit the Enter key on keyboard 162 to initiate the search for that search term. Alternatively or additionally, a search may be initiated after passage of a preset period of time (e.g. 5 seconds) after a search has been entered and no further key strokes are detected. Other possibilities for initiating a search after entry of the search term are contemplated.

A wide variety of natural language search protocols may be used to find suggested functions based on the search term. In one embodiment, the search protocols used may be those conventionally used by various Microsoft® Office application programs when entering a natural language search term in the application program's help menu. Various other natural language search technologies are known and may be used in alternative embodiments. While using a natural language search in search field 216 provides an advantage of simplifying the process of finding the desired function for a user, it is understood that structured searches may be performed in search field 216 in alternative embodiments.

Upon entry of a search term, the application program initiates a search of a database including all formulas. The database that is searched may be stored locally on the user's computing system environment 100, for example in memory 140. Alternatively, the database that is searched may be located on remote computer 180 which is accessed using local area network 171 or wide area network 173 such as the Internet. In alternative embodiments, two separate databases of functions may be searched, one stored locally and one stored remotely. The search results are returned in step 310.

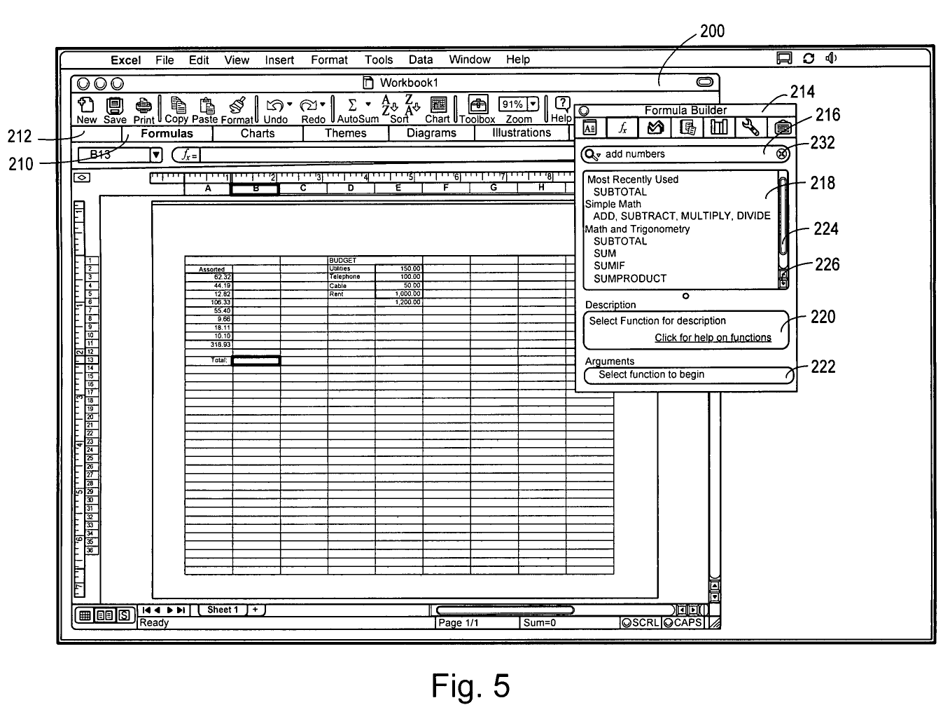

As one example of a function, a user may wish to add together one or more groups of numbers on the spreadsheet. In the example of FIG. 2, the spreadsheet has various values in Column A (under the label “Assorted”) and various values in Column C (under the label “Budget”). The user may wish to add the numbers in Columns A and C, and place the results in, for example, cell B13. This example is by way of illustration only and not intended to limit the invention. In order to find the appropriate function to perform this operation, a user may type in the natural language search “add numbers” in the search field 216 as shown in FIG. 5. The search returns suggested functions in the library field 218 as shown in step 310. It is understood that the user may have typed in various other search terms in the search field, such as “sum numbers,” “adding number,” “addition,” etc., and in embodiments gotten the same results in library field 218.

The search results returned in library field 218 may be organized a variety of ways. In the embodiment of FIG. 5, the results are organized by category and then alphabetically within each category. In embodiments, the same categories may be presented for each search, with the results within one or more of the categories varying depending on the search term. In alternative embodiments, both the categories and the results within each category may vary depending on the search term. As one example, the search results may be organized alphabetically under categories such as MOST RECENTLY USED, SIMPLE MATH and MATH AND TRIGONOMETRY. The MOST RECENTLY USED category may be functions that have been selected in past uses of the formula builder tool, and which have been stored in memory, such as for example memory 140. In embodiments, the number of functions presented in the most recently used category may be ten, but may be more or less than that in alternative embodiments. The SIMPLE MATH may be the most commonly used math functions, such as for example, Add, Subtract, Multiply, Divide, Math, Calculate, Total, Minus and Times. Other functions may be used in addition to or instead of these functions in alternative embodiments. The MATH AND TRIGONOMETRY functions may be those which most closely relate to the search query, based on the search of the term entered in the search field 216.

The results of the search of the term entered in the search field 216 may alternatively be presented simply alphabetically, without being broken down into categories. Alternatively, the results could be presented in a so-called relevancy listing, in which results which are expected to be most highly related to the search term are put first and results of expected decreasing relevance following thereafter. Various schemes are known for weighting results of a search based on an expected correlation of a result to the searched term. The results can alternatively be broken down into categories as described above, with the results in each category presented in a relevancy listing. Those of skill in the art will appreciate other methods of organizing the results presented in library field 218 in response to a search term in search field 216. The user may navigate through the results using scroll bar 224, buttons 226 and/or alpha matching.

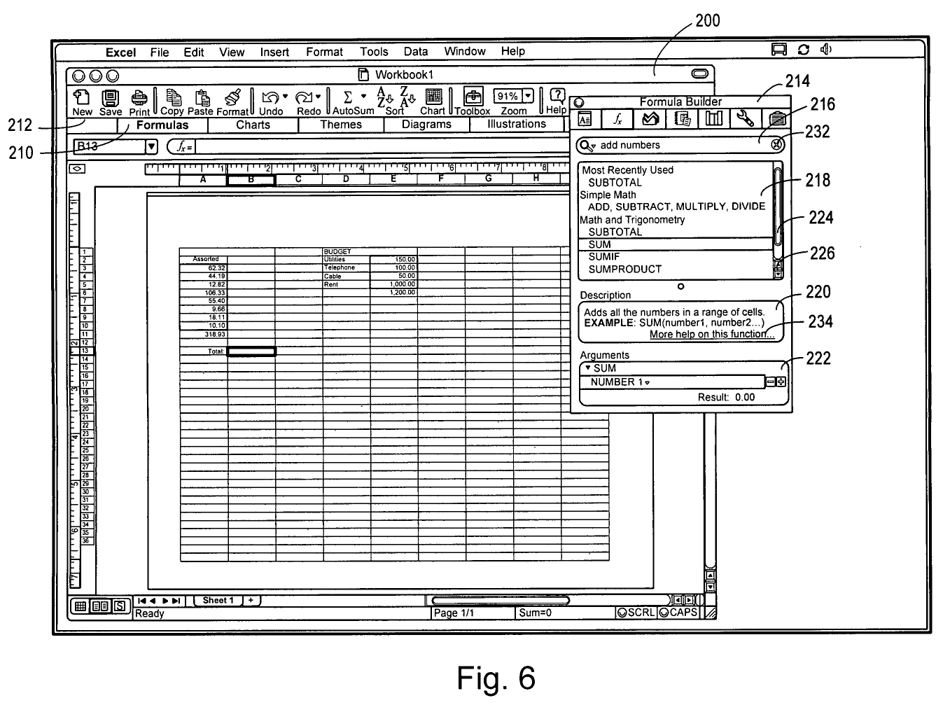

After scanning the search results presented in step 310, if the user does not find the desired results in step 314, the user may return to step 306 and perform a new search. Alternatively, if the desired results are found, the user may select that function with pointing device 161 in a step 316 and as shown in FIG. 6. In embodiments, the category headings (MOST RECENTLY USED, SIMPLE MATH and MATH AND TRIGONOMETRY) are not themselves selectable. Once a user selects a function, the selected function may at that point be added to the selected cell (without arguments) as described hereinafter.

When a search result from library field 218 is selected, the spreadsheet application program may provide a brief description of that function, which description may be set forth in description field 220 in step 318. The brief description may explain the operation of the function, the function syntax, as well as the arguments required for the function. This description may be taken from data files conventionally stored in memory 140 upon installation of the spreadsheet application program on computing system environment 100. Typically, the information contained in these files may also be made available to the user upon accessing the Help option on the menu bar. Instead of or in addition to the information that is stored locally, the description field 220 may also be populated with information received from a remote location over networks 171 or 173.

A link 234 may also be provided in the event the user wishes additional information on the selected function. Accessing link 234 may cause the spreadsheet application program present a help window on display 191 with further help topics on the selected function. The content populating the help window may come from data files associated with all of the various functions, which data files conventionally exist in help files stored on the memory 140 or remotely, as described above.

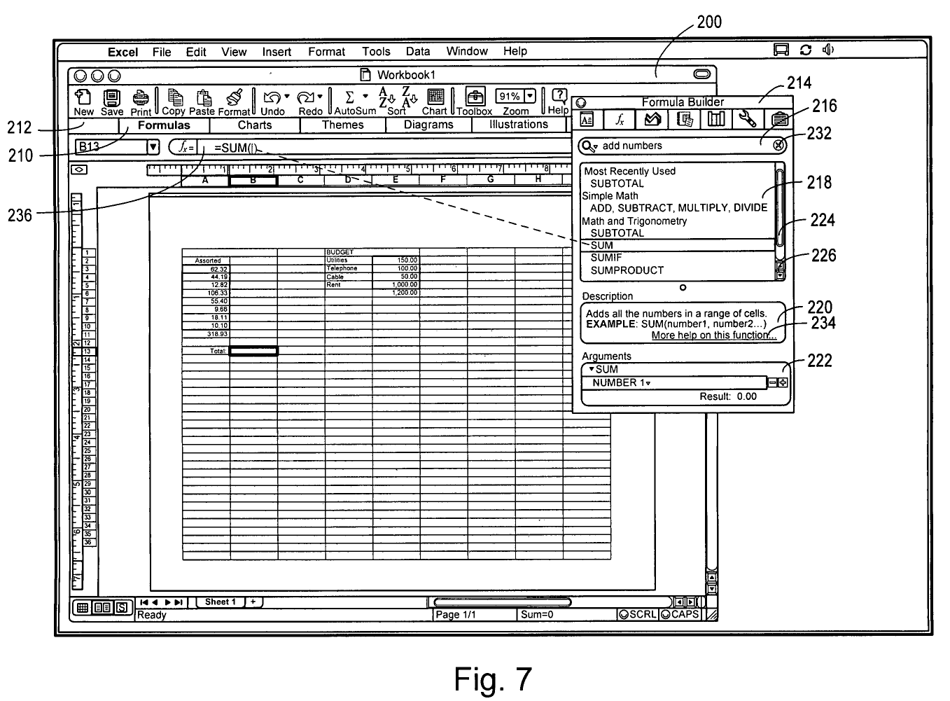

The user may apply a selected function to a selected cell in a number of ways. A user may “click and drag” the function from the library field 220 to a formula bar 236 in a step 320 and as shown in FIG. 7. “Click and drag” refers to the known process of selecting an object with the pointing device 161 by actuating the pointing device with the associated graphical pointer on the graphical user interface located over the object to be selected. Then, with the pointing device remaining in the actuated position, moving the selected object to the desired location on the graphical user interface, in this instance, the formula bar 236. Formula bar 236 may be as conventionally provided in graphical user interface of spreadsheet application programs. Where a user does not wish to make use of the formula builder according to the present invention, the user may be able to add and alter functions to a spreadsheet 202 using the formula bar 236 as is known in the art.

In embodiments, adding the selected function to the formula bar 236 also automatically adds the function to the selected cell as is known in the art. In an alternative embodiment, the user may click and drag the selected function from the library field 220 directly to the selected cell. In such an embodiment, the selected formula may also then be displayed in the formula bar 236 as is known in the art. Instead of or in addition to clicking and dragging the selected function from the library field 220, the selected function may be inserted into the desired cell and formula bar by striking the Enter key on keyboard 162 and/or by “double clicking” on the selected function in the library field 220. “Double clicking” is the known process of two rapid actuations of the pointing device 161 while the graphical pointer on the graphical user interface located over the object being selected. A box 260 may also be provided adjacent the selected cell and/or the formula bar showing the proper syntax and arguments required for the selected function.

In addition to adding a formula to the selected cell and formula bar, the a user may copy the function selected in the library field 220 to the application clipboard, using the “Edit>Copy” option from the menu bar, or other known methods of copying information to the application clipboard (such as the copy option from drop down menu upon a right click of the pointing device 161, or by keying in Ctrl+C from the keyboard 162). The user may thereafter paste that function (at this point without arguments) in the formula bar 236 or one or more cells as desired.

Once the function is added to the selected cell/formula bar, the spreadsheet application program checks whether the selected function requires any arguments for its operation in step 322. If so, they are added in steps 324-334. An argument is one or more variables or constants, taken from other cells in the spreadsheet 202, that determine the value or result of the selected function. If no arguments are required, the formula builder tool skips to step 338 and inserts the overall result in the reference cell.

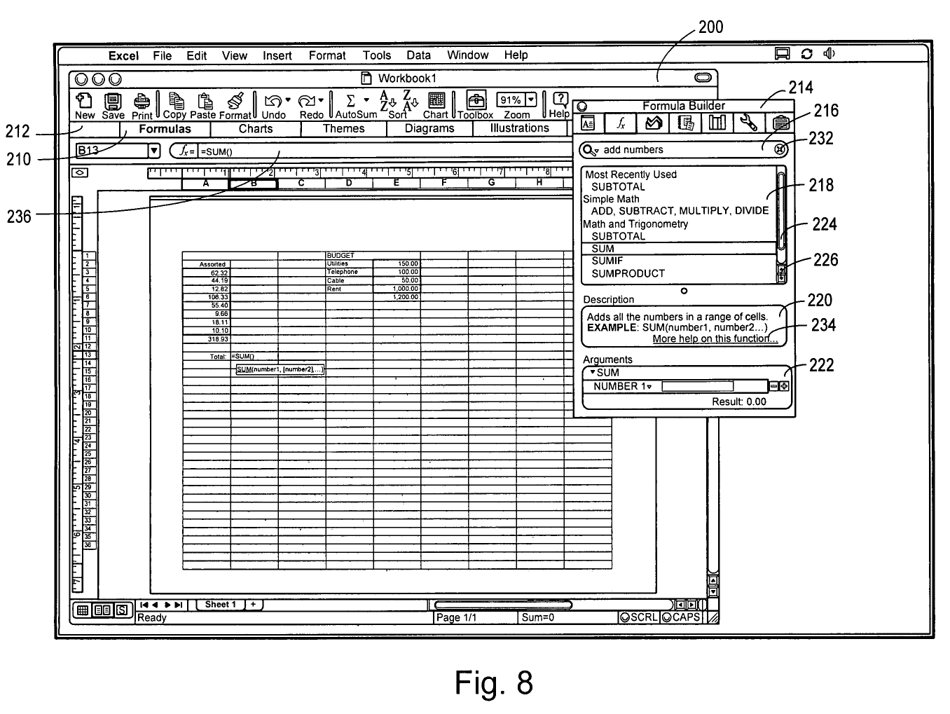

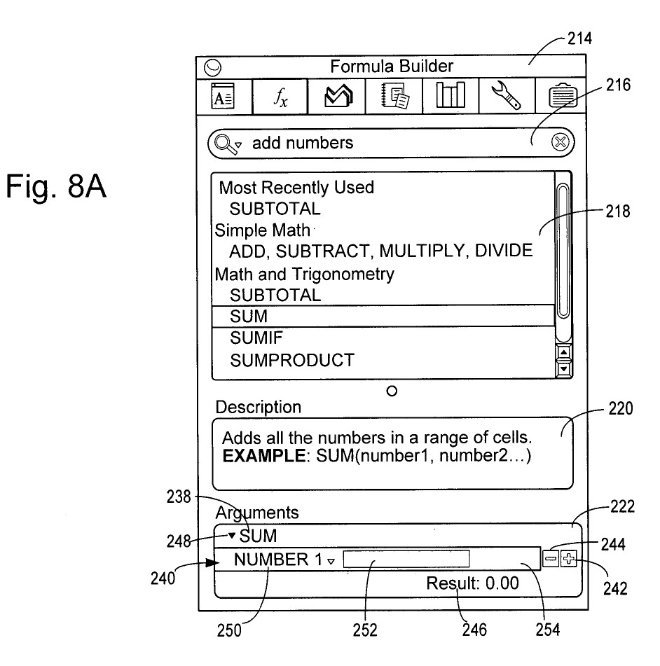

If arguments are required for the specified function, the arguments are added in the arguments field 222. When no function is specified, the arguments field 222 may display text indicating that the argument field is awaiting selection of a function, such as for example, “Select function to begin” as shown in FIG. 4. Once a function is specified, the arguments field 222 is altered in step 324 to display a header specifying the selected function, and an argument template. The argument template includes information known about the specified function and includes data entry box(es) for prompting the user to add information required to perform the function. The header and argument template are explained in greater detail with respect to FIGS. 8-10.

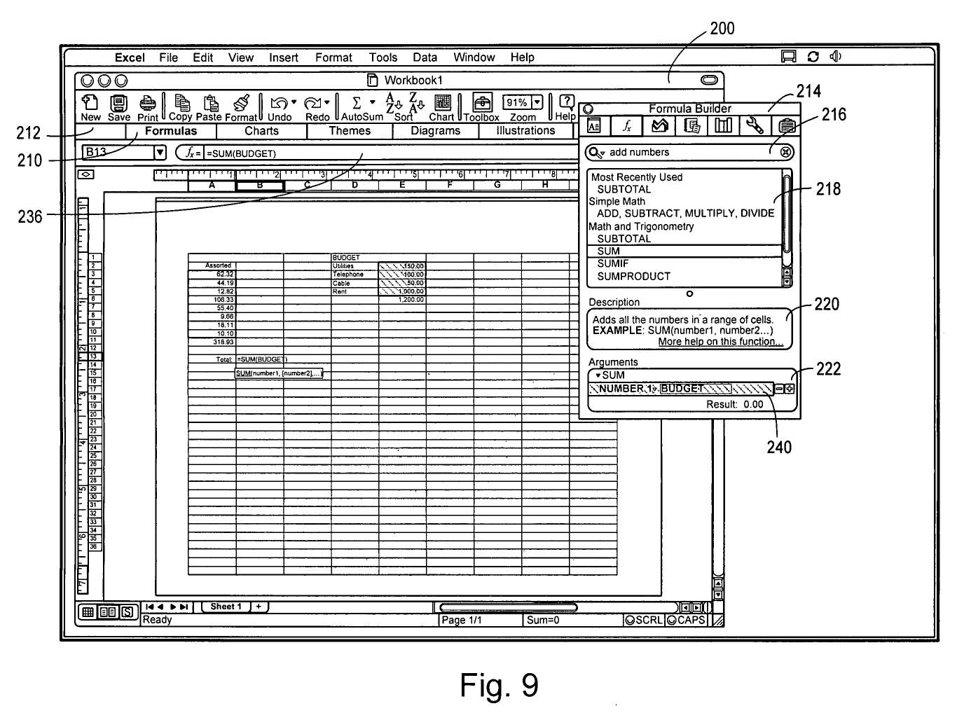

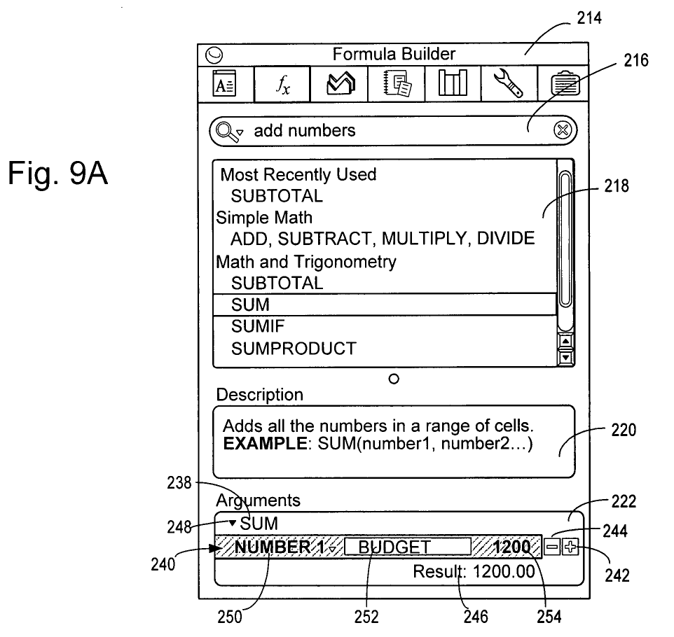

As best seen in FIGS. 8A and 9A, the header 238 shows the function name. A disclosure triangle 248 may be presented next to the header 238 that, if clicked, collapses or expands the arguments field 222. The disclosure triangle 248 may be omitted in alternative embodiments. One or more argument templates 240 may be provided below the header 238. Each argument template 240 describes one argument used by the function, and there is one argument template 240 for each argument in the function. In embodiments, the argument template 240 shows the argument type 250 (e.g., number, text, row number, column number, etc.), the range 252, which is a data entry box for entry of the cell numbers used for the argument (e.g., A3:A10) and the argument result 254, which refers to the result indicated by the argument.

Once a function is specified argument templates for at least the minimum number of arguments required for the function are displayed in arguments field 222. The argument type 250 is also displayed for each of the argument templates provided.

The range 252 is configured as a text box, and the user may enter the range 252 in step 326 by typing in the cell numbers to be used in the argument. Alternatively, with the cursor positioned in the range 252 text box, the user can select the cells in the range (as is known by dragging the graphical pointer from one corner to the diametrically opposed corner of the cells to be included), and those cell numbers will be added to the range 252. The range 252 may be edited by clicking on an argument type 250 and entering the new cell numbers in range 252. The entry is accepted on return/enter of keyboard 162.

Once the range 252 is entered, the application program calculates the argument result (step 328) for that argument template (if any), and the overall result (step 330) for the function based on the argument(s) provided. The add box 242 may be clicked on with the pointing device to add a new argument, or argument template 240. The remove box 244 may be clicked to remove the associated argument template 240.

An illustrative example is shown in FIGS. 9 and 9A. In this example, the first argument, NUMBER 1, is the sum of the cells under the label “BUDGET” in Column E. The SUM function requires at least one argument, so one argument template is displayed. The argument template shows the argument type, NUMBER 1, and a text box for entry of the range. The cells included in the range for BUDGET are cells E2 to E5. The user could enter the range “E2:E5” in range 252. Alternatively, as is known in conventional spreadsheets, the column label “BUDGET” may be typed into range 252 or entered by selecting the cell containing the label BUDGET. As a further alternative, with the cursor within the range text box 252, the user can select cells E2 to E5. As a result of adding the range by any of the above methods, the application program calculates the argument results 254, which in this case is the sum of the cell range for NUMBER 1, or 1200. The application program may also calculate the overall result 246 at this point in the example based on the argument results 254, which in this case is the sum of the cell range for NUMBER 1, or 1200.

As or after an argument template is added into the arguments field 222, that argument may appear, in the proper syntax, between the parentheses in the formula bar 236 and in the selected cell as shown in FIG. 9. By prompting the user for the arguments in this manner, the present invention allows arguments to be easily added to a function without the user having to know or necessarily understand the proper syntax required for the selected function.

Moreover, according to embodiments of the present invention, in order to allow a user to easily see which cells form a given argument to a function, both the argument template and the cells included in the argument template may be color coded with a background color in step 332. In the example shown in FIG. 9, the argument template 240 for NUMBER 1 is made up of cells E2 to E5. Thus, a semi-transparent background color may be applied to the argument template 240 for NUMBER 1 (indicated by hatching in FIGS. 9 and 9A) and the same semi-transparent background color may be applied to cells E2 to E5. For example, argument template 240 for NUMBER 1 and cells E2 to E5 may be shaded with a semitransparent blue background. However, a wide variety of colors and/or patterns may be used.

The colors of an argument template and its associated cells are preferably the same color. However, it is understood that the colors of the argument template and its associated cells may be slightly different, provided it is sufficiently clear that the colored cells are linked to the associated colored argument template. Moreover, while the entire area of argument template and associated cells are shown as colored, it is understood that only a portion of the argument template and/or a portion of the cell block may be colored in alternative embodiments. As explained below, when additional arguments are added, the argument template for the new argument, and the cells associated with the new argument template, receive a new color different than the color of the first argument. Thus, a user may easily see which cells are used in which arguments and how the argument results 254 and overall results 246 are derived.

The spreadsheet application program next checks if the user wishes to add additional arguments in step 334. If not, the user may click outside of the formula builder window 214 and referenced cell, and the overall result may then be presented in the referenced cell in step 338.

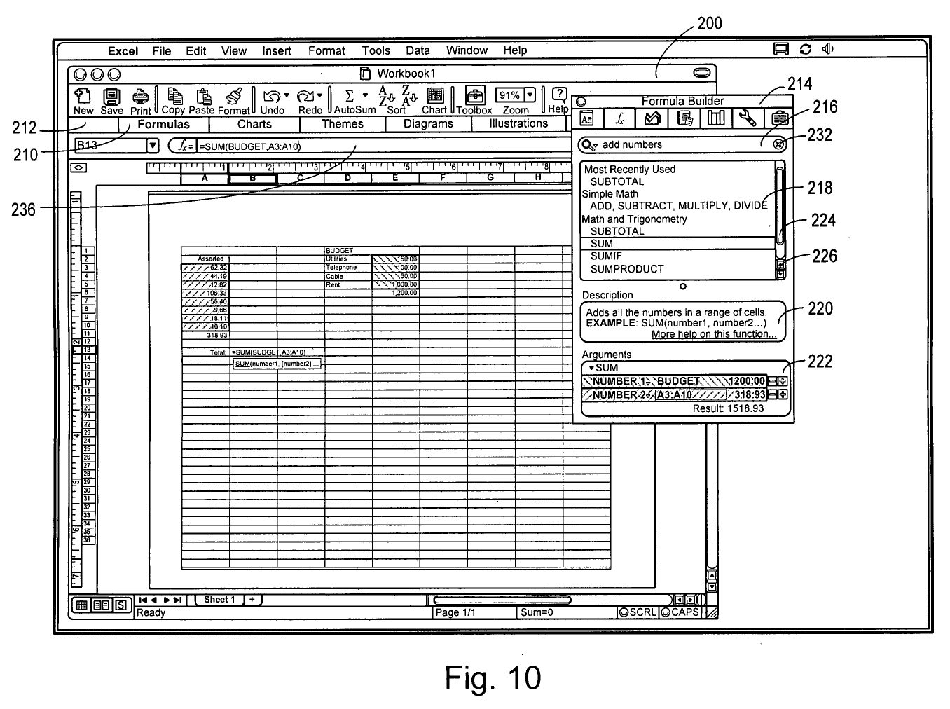

If more arguments are to be included, the add button 242 may be clicked in step 336 to generate a new argument template and the application program returns to step 326 to fill out the required information for the new argument template. In this example, there are additional cells which are to be included in the sum. The numbers listed under “Assortment” in cells A2 to A9 form the second argument of the function placed in cell B13. In order to add the second (or subsequent) argument, the add button 242 in the first argument is clicked. This creates a new argument template as shown in FIG. 10. The new argument template has argument type 250 listed as NUMBER 2, range 252 as “A2:A9”, and argument result as 318.93. The overall result 246 for the sum of NUMBER 1 and NUMBER 2 is shown to be 1518.93.

As described above, cells A2 to A9 and the argument template NUMBER 2 may both be color coded with the same background color (indicated by reverse hatched lines in FIG. 10). For example, the argument template NUMBER 2 and cells A2 to A9 may have a semitransparent green background (while the argument template NUMBER 1 and cells E2 to E5 may have a semitransparent blue background). Thus, a user may easily see which cells are used in arguments NUMBER 1 and NUMBER 2, and how the argument results 254 and overall results 246 are derived.

While colors have been described above as the visual indicators for indicating the association between a argument template and the cells used in that argument template, it is understood that other visual indicators may be used in alternative embodiments. For example, instead of a transparent background color, one or both of the argument template and the associated cells may instead be outlined with a color. Alternatively, the argument template and the associated cells may share a common pattern, as a semitransparent background, or as an outline around the argument template or associated cells. Instead of each argument template/associated cell having a distinct color or visual indicator, it is understood that all argument templates and all cells used in a function may have a single color to distinguish the cells in a function from cells not used in the function. It also understood that the overall result 246 and the cell selected to receive the overall result may have a common visual indicator such as a common background color.

If there are no further arguments to be added and the function is completed, the user may click outside of the formula builder box and outside of the referenced cell, and the overall result may be placed in the referenced cell in step 338. The formula builder box may remain open, it may be minimized, or it may be closed, either by the user or automatically after a function result is placed in the referenced cell.

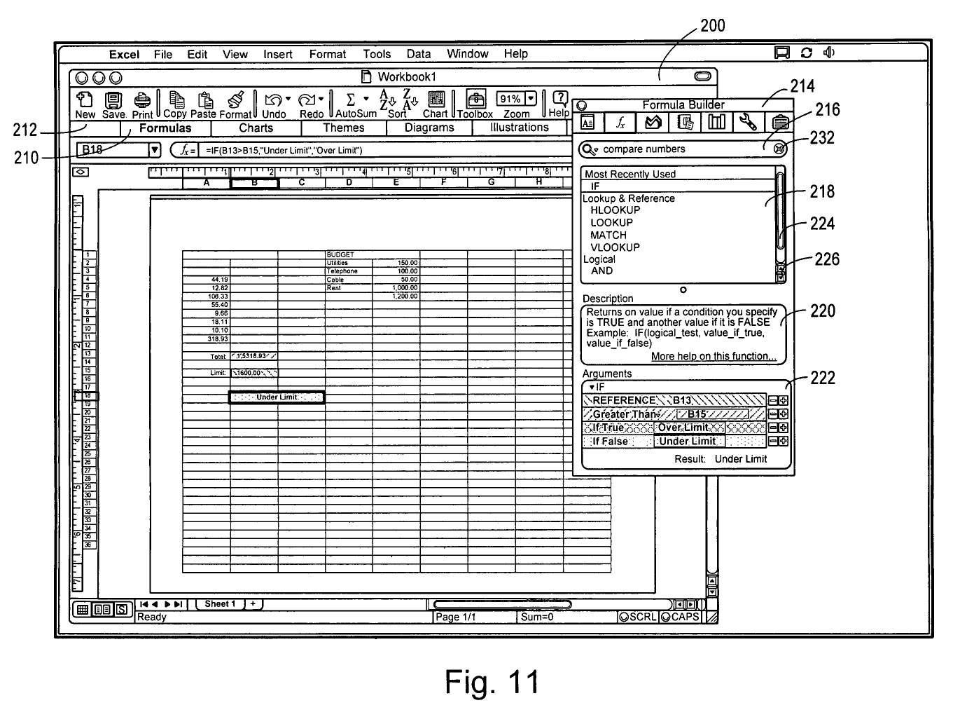

FIG. 11 is a further embodiment of the present invention where a user wishes to compare the results in cell B13 obtained in the example of FIGS. 5-10 with a value listed in cell B15. If the value in B13 is over the value of B15, then a reference cell, for example B18 should read “Over Limit.” If the value of B13 is under the value of B15, B18 should read “Under Limit.”

The proper function for performing this operation is the IF function, and its syntax is IF(logical_test,value_if_true,value_if_false). Even if a user knew the correct function, the user may not understand what needs to be included as the arguments or how to provide the information in the proper syntax.

Therefore, according to the present invention, the user may open the formula builder window 214 and enter a natural language search term in search field 216, such a for example “Compare numbers.” Other search terms are possible. A search of this term may give the results shown in library field 218. Upon highlighting the various functions, the user may quickly determine that the desired function is the IF function, and the user may add that function to the formula bar or reference cell.

Upon adding the function, the arguments field may present the header, IF, and four argument templates. The first argument template prompts the user for the first argument, which in this case is cell B13. The user may add this cell to the range as described above. The second argument is the logical test and the second reference. The second argument template may select “Greater than” present a drop down menu of logical comparisons by clicking on arrow 270, and may add the second reference cell, B15. The third argument template is what is to be put in the reference cell if the condition is true, and the fourth argument template is what is to be put in the reference cell if the condition is false. As would be understood, the one or more argument templates are formatted to present information and prompt for information depending on the particular function that is selected. Each argument template may further include a help icon which, if accessed with the mouse pointing device, presents help files stored locally or remotely with additional information on the argument described by that argument template.

Upon entering the information in the argument templates, the result is returned, “Under Limit” in this example, which is presented in the overall result, and in reference cell B18. The function with proper syntax is also shown in the formula bar. It is understood that instead of a textual result (“Under Limit” or “Over Limit”), the “if true” and/or the “if false” result could have been to perform a further function.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

I claim:

1. A method of building a desired function in an application program using in part data provided to the application program, the data being represented at a location on a graphical user interface, the method comprising the steps of:
(a) presenting a graphical user interface including a predefined function;
(b) presenting a graphical user interface for receiving information relating to an argument used by the predefined function, the information at least in part including information relating to the location where a portion of the data is represented; and
(c) indicating an association between the argument and the location where the portion of the data is represented with a visual indicator.

2. A method as recited in claim 1, further comprising the step of presenting a graphical user interface for receiving information relating to the desired function, the predefined function presented at least in part in response to the received information relating to the desired function.

3. A method as recited in claim 1, further comprising the step of presenting a graphical user interface presenting a description of the predefined function.

4. A method as recited in claim 1, said step (c) of indicating an association between the argument and the location where the portion of the data is represented with a visual indicator comprising the step of providing a colored background to both the argument and the location.

5. A method as recited in claim 1, said step (c) of indicating an association between the argument and the location where the portion of the data is represented with a visual indicator comprising the step of providing a similar pattern or outline to both the argument and the location.

6. A method as recited in claim 1, further comprising the step of presenting a graphical user interface for receiving information relating to a second argument used by the predefined function, the information at least in part including information relating to the location where a second portion of the data is represented.

7. A method as recited in claim 6, further comprising the step of indicating an association between the second argument and the location where the second portion of data is represented with a second visual indicator, the second visual indicator being different than the first visual indicator.

8. A method as recited in claim 1, the application program comprising a spreadsheet application program and the location representing the portion of the data being one or more cells on a computerized spreadsheet, said step (c) of indicating an association between the argument and the location where the portion of the data is represented with a visual indicator comprising the step of providing a colored background to both the argument and the one or more cells.

9. A method of building a desired function in a spreadsheet application program comprising the steps of:
(a) presenting a graphical user interface for accepting a query relating to the desired function;
(b) presenting a graphical user interface with one or more predefined functions in response said step (a) of presenting a graphical user interface for accepting a query; and
(c) presenting a graphical user interface customized to a predefined function of the one or more predefined functions presented in said step (b), the graphical user interface presented in said step (c) capable of accepting information relating to one or more arguments for the predefined function.

10. A method as recited in claim 9, said step (c) of presenting a graphical user interface customized to a predefined function allowing a user to input the information relating to the argument in a form different than that required by the syntax of the predefined function.

11. A method as recited in claim 9, said step (a) of presenting a graphical user interface for accepting a query relating to the desired function comprising the step of presenting a graphical user interface for receiving a natural language search including terms related to the desired function.

12. A method as recited in claim 9, further comprising the step of presenting a graphical user interface presenting a description of the predefined function.

13. A method as recited in claim 9, the graphical user interface presented in said step (c) including one or more portions corresponding to the one or more arguments of the predefined function, each portion of the one or more portions having a different color.

14. A method as recited in claim 9, the information relating to one or more arguments for the predefined function in said step (c) comprising one or more cells on a graphical spreadsheet, the one or more cells including data for use in the one or more arguments for the predefined function.

15. A method as recited in claim 14, further comprising the step of indicating an association between the one or more cells and at least a portion of the graphical user interface presented in said step (c) with a visual indicator shared by the one or more cells and the portion of the graphical user interface.

16. A method as recited in claim 15, said step of indicating an association between the one or more cells and at least a portion of the graphical user interface presented in said step (c) comprising the step of providing at least one of a colored background, a colored outline or a pattern to both the one or more cells and the portion of the graphical user interface.

17. A computer-readable medium having computer-executable instructions for programming a processor to perform a method of building a desired function in a spreadsheet application program using in part the positions of cells on a graphical spreadsheet, the cells including data, the method comprising the steps of:
(a) receiving information relating to the desired function;
(b) presenting a plurality of predefined functions selected at least in part based on the information received in said step (a);
(c) allowing the selection of a predefined function from the plurality of predefined functions presented in said step (b)
(d) receiving information relating to an argument of one or more arguments used by the selected function, the information at least in part including a first group of one or more of the cells; and
(e) indicating an association between the argument and the first group of one or more cells by with a visual indicator shared by the argument and first group of one or more cells.

18. The computer-readable medium having computer-executable instructions for programming a processor to perform a method as recited in claim 17, said step (d) of receiving information relating to an argument of one or more arguments used by the selected function comprising allowing a user to input the information relating to the argument in a form different than that required by the syntax of the predefined function.

19. The computer-readable medium having computer-executable instructions for programming a processor to perform a method as recited in claim 17, further comprising the step of receiving information relating to a second argument used by the predefined function, the information at least in part including information relating to a second group of the one or more cells.

20. The computer-readable medium having computer-executable instructions for programming a processor to perform a method as recited in claim 19, further comprising the step of indicating an association between the second argument and the second group of one or more cells with a second visual indicator, the second visual indicator being different than the first visual indicator.
